(19) United States
(12) Patent Application Publication
(10) Pub. No.: US 2011/0040772 A1
(43) Pub. Date: Feb. 17, 2011

(54) Capability Based Semantic Search System

(76) Inventor: Chen-Yu Sheu, Irvine, CA (US)

Correspondence Address: Chen-Yu Sheu, 7 WHISTLER CT, IRVINE, CA, 92617, US

(21) Appl. No.: 12/583,202

(22) Filed: Aug. 17, 2009

(51) Int. Cl. G06F 17/30; G06F 17/27; G10L 13/08

(52) U.S. Cl. 707/755; 704/E13.011; 707/E17.014

(57) ABSTRACT

This invention is related to a capability-based semantic search system that allows search of web tools and/or content to be done by comparing the need of a user described in a structured query language and the capabilities of solutions(services) described in another structured query language. The invention provides a new trading infrastructure between problems and solutions on the Internet.

### BACKGROUND OF THE INVENTION

1. Field of the Invention

This invention is related to a capability-based semantic search system (CBSSS) that allows search of web tools and/or content to be done by comparing the need of a user described in a structured query language and the capabilities of services described in another structured query language. The invention provides a new trading infrastructure between problems and solutions on the Internet.

2. Description of the Related Art

### Semantic Computing

Semantic Computing is an emerging field that addresses the derivation and matching of the semantics of computational content to that of naturally expressed user intentions in order to retrieve, manage, manipulate or even create content, where ‘content’ may be anything including video, audio, text, process, service, hardware, network, community, etc. The connection between content and the user can be made via (1) Semantic Analysis, a process aimed at analyzing content with the goal of converting it to a description (semantics); (2) Semantic Integration, which integrates content and semantics from multiple sources for eliciting the embedded knowledge; (3) Semantic Applications, which utilize content and semantics to solve domain-specific problems; and (4) Semantic Programming and Interfaces, which attempt to interpret naturally expressed user intentions. The reverse connection converts descriptions of user intentions to create content of various sorts by synthesizing reusable building blocks.

### Web Service Composition

Much research related to web services composition has been done to provide platforms and languages for composing heterogeneous systems, such as Universal Description, Discovery, and Integration (UDDI), Web Services Description Language (WSDL), Simple Object Access Protocol (SOAP) and part of OWL-S ontology (ServiceProfile and ServiceGrounding). Such platforms and languages try to define standard ways for service discovery, description and invocation (message passing). Other initiatives such as Business Process Execution Language for Web Service (BPEL4WS) and OWL-S ServiceModel are focused on representing workflows of service composition. Two main techniques are flow-based composition (such as EFlow, composite service definition language (CSDL), Polymorphic Process Model (PPM) and Al based composition such as Situation calculus) and Rule-based planning. Despite of all these efforts, automatic web service composition still has a long way to go. The internal logic of each web service is every difficult to catch, and services discovery is also difficult no matter UDDI or an ontology-based method is used for service description.

### SUMMARY OF THE INVENTION

For purposes of summarizing the invention, certain aspects, advantages and novel features of the invention have been described herein. It should be understood that not necessarily all such aspects, advantages or features will be embodied in any particular embodiment of the invention.

This invention provides a capability-based semantic search system that allows search of web services to be done by comparing the need of a user described in a declarative query language and the capabilities of services described in another declarative language. Those services whose capability can match the user's need are returned as the result of the search. This is different from traditional search systems in which user needs are expressed in terms of keywords and the capability of a service is described in natural language text.

### DETAILED DESCRIPTION OF THE PREFERRED EMBODIMENT

The following subsections describe a semantic search system that embodies various inventive features. The various inventive features can be implemented differently than described herein. Thus, the following description is intended only to illustrate, and not limit, the scope of the present invention.

### Architecture of CBSSS

The Capability Based Semantic Search System (CBSSS) provides users with a problem-driven interface to search for a solution according to users' requirements. The architecture of CBSSS is shown in FIG. 1:
1. User Interface 110, a query interface through which a consumer can pose SQDL query sentences.
2. User Interface 120, a query interface through which a service provider can pose capability sentences in SCDL.
3. SCDL Base 130 that sores all SCDL sentences provided by providers.
4. SQDL & SCDL Matcher 140, that matches SQDL to SCDL sentences. Given an SQDL query sentence, the matcher tries to find a list of services where the SCDL description of each indicates it is capable of solving the query. If no single service can fulfill the requirement, the matcher will decompose the SQDL query into several simpler queries, and try to find a series of services that may answer the query.
5. Service Invoker 150, that invokes and communicates with the matched services on behalf of the user to get the final solution.

### Semantic Capability Description Language (SCDL)

Semantic Capability Description Language (SCDL) is an SQL-like description language that may be utilized to describe the functionality and capability of a web service, with an objective to support automatic service composition. The syntax of SCDL for a web service WS is similar to that of SQL, as expressed in the following generic form:
SELECT outputs (O₁, . . . , Oₘ), aggregated-outputs (ƒ₁(A₁), . . . , ƒ_{d}(A_{d}))
FROM inputs (I₁, . . . , Iₘ), variables (R₁, . . . , Rₙ), other variables (S₁, . . . , Sₖ)
WHERE p(inputs, outputs, other variables)
GROUP BY (H₁, . . . , Hⱼ)
   where O₁, . . . , Oₘ are output objects, ƒ₁(A₁), . . . , ƒ_{d}(A_{d}) are possible aggregation functions, I₁, . . . , Iₘ are input objects, R₁, . . . , Rₙ are some range variables, S₁, . . . , Sₖ are sets that may be derived from the inputs and the range variables, H₁, . . . , Hⱼ are the variables based on which to group the output objects, and p(inputs, outputs, other variables) is a formula that describes the relationships among the inputs, the outputs and the variables. SCDL allows variables to be typed, and it allows a function to be included as a condition in the WHERE clause. A major difference between SCDL and SQL is that SCDL allows “exponential variables”, where the domain of an exponential variable could be the set of all subsets of an existing set, and it allows variations of exponential variables to represent biological variables. The corresponding algebraic expression of an SCDL expression is as follows:

WS(I₁, . . . , Iₘ;O₁, . . . , Oₘ)=_{(H}_{₁}_{, . . . , H}_{ⱼ}₎G_{(ƒ}_{₁}_{A}_{₁}_{, . . . , ƒ}_{_{d}}_{A}_{_{d}}_{)Π(σ}ₚ(R₁x . . . x Rₙx S₁x . . . x Sₖ))

Note that while an SCDL expression may be executable, in practice it is often not realistic to do so. The language is utilized for the purpose of service discovery/synthesis only. By comparing the capability of a service expressed in SCDL and a query in SQDL, a match may be determined.
Following are some example services whose capabilities are described in SCDL:
Service 1: Given a dataset, classify blobs of images in a dataset.
[SCDL]
SELECT i
FROM INPUT string dataset, image:dataset i, blob c, INPUT string type
WHERE contains(i,c) and isa(c,type)
   Service 2: Given an image dataset, identify blob clusters that look like a structure.
[SCDL]
SELECT s
FROM INPUT string dataset, image:dataset i, setof-blob 2^{i.blob( )} s, INPUT string structure
where like(s,structure)
   Service 3: Given a dataset, identify blob clusters not overlapping with other blob clusters.
[SCDL]
SELECT s,t
FROM INPUT string dataset, image:dataset i, setof-blob 2^{i.blob( )} s, setof-blob 2^{i.blob( )} t where not overlapping(s,t)
   Service 4: Given a (cube) dataset, find distribution of measure over dimensions.
[SCDL]
Show q
FROM INPUT string dataset, cube:dataset p, cube q, INPUT setof-string dimensions,

INPUT setof-string measure
WHERE sub-qube(q,p)
   Service 5: Given a set of video clips, find those containing a scene similar to a given scene.
[SCDL]
SELECT c
FROM INPUT string dataset, clip:dataset c, scene s1, INPUT scene s2
WHERE includes(c,s1) AND similar(s1.s2)

### Service 6: [Text] Q&A?

[SCDL]
SELECT h
FROM URL h, INPUT text Q
WHERE contain-answer-for(h,Q)

FIG. 2 shows one embodiment of a computer-implemented process of composing an SCDL sentence. If the user wants to define any input variable, the process proceeds to a block 210, where the user defines the name and the type of an input variable. Next, if the user wants to define any additional variable, the process proceeds to a block 220, where the user defines the name and the type of an additional variable. At a block 230, the process asks the user to select a command from a list of defined commands. If it requires any parameter, the process proceeds to a block 240, where the user specifies the value of the parameter. If the user wishes to select a condition, then the process proceeds to a block 250, where the user is prompted to select a condition from a list of defined conditions. If the selected condition requires any parameter, the process proceeds to a block 260, where the user specifies the value of the parameter.

### Semantic Query Description Language (SQDL)

SQDL is similar to SCDL, except that all input variables are instantiated to a constant.
A query in SQDL is presented as:
SELECT objects, object attributes and/or functions
FROM object declarations [WHERE Boolean functions]
   Problem 1: Show all blobs in image dataset ‘cmd-232’ that are tangles.
[SQDL]
SELECT i
FROM image: ‘cmd-232’ i, blob c
WHERE contains(i,c) AND isa (c,‘tangle’)
   In the above, “images:dataset i” declares a variable i whose type is image and whose domain is ‘cmd-232’. The query looks for a service to solve the problem.
   Problem 2: Locate all those blob clusters that are satellite-like in image dataset ‘cmd-232’.
[SQDL]
SELECT s
FROM image: ‘cmd-232’, i, setof-blob:2^{i.blob( )} s // s is a set of blobs
where contains(i,s) AND like(s,‘satellite’)
   In the above, 2^{i.blob( )} designates all subsets of blobs that can be derived from the blobs in image i, and a set of blobs forms a “satellite-like” structure if a large blob is sitting in the middle with several small blobs around within a certain distance.
   Problem 3: Locate all those blob clusters that are satellite like and not overlapping with other blob clusters in image dataset ‘cmd-232’.
[SQDL]
SELECT s
FROM image: ‘cmd-232’ i, setof-blob:2^{i.blob( )}s, setof-blob:2^{i.blob( )}t
where contains(i,s) AND like(s,‘satellite’) AND contains(i,t) AND like(t,‘satellite’) AND not overlapping(s,t)
   Problem 4: Based on dataset ‘cmd-235’, find distribution of tangles over regions and diseases.
[SQDL]
Show q
FROM cube: ‘cmd-235’p, cube q
WHERE sub-qube(q,p) AND q.dimensions=[‘region’,‘disease’] AND q.measure=[‘#tangle’]
   Problem 5: Find video clips of dataset ‘vmd-621’ that contains a scene similar to scene ‘smd-777’.
[SQDL]
SELECT c
FROM clip:‘vmd-621’ c, scene s
WHERE include(c,s) AND similar(s, ‘smd-777’)
   Problem 6: Find web pages that may answer the question “What are the symptoms of moderate AD?”
[SQDL]
SELECT u
FROM URL:u
WHERE contain-answer-for(u,‘What are the symptoms of moderate AD?)
   Note that some problems cannot be solved by a single service alone.

FIG. 3 shows one embodiment of a computer-implemented process of composing a structured query sentence in SQDL. If the user wants to define any variable, the process proceeds to a block 310, where the user defines the name, the type and the domain of a variable. At a block 320, the process asks the user to select a command from a list of defined commands. If the command selected requires any parameter, the process proceeds to a block 330, where the user specifies the value of the parameter. If the user wishes to select a condition, then the process proceeds to a block 340, where the user is prompted to select a condition from a list of defined conditions. If a condition selected requires any parameter, the process proceeds to a block 350, where the user specifies the value of the parameter. Note that no INPUT variable may be included in an SQDL sentence.

### Service Discovery

Service discovery in CBSSS contains two phases: service registration and service matching.

Service Registration: In order to be discovered by CBSSS, services have to register in advance. Service providers have to provide service information, including service URL, namespace, SCDL description, etc.

Service Matching: When user poses an SQDL query, the SQDL & SCDL Matcher handles the matching between the SQDL query and the available SCDL descriptions. The matching process consists of two parts. The first part is interface matching—the matcher parses the interface description from the SQDL query to that of the SCDL description of each registered service. The second part is conditions matching—the matcher parses the conditions from the SQDL query to those of each SCDL description. Based on proper unifications, the matcher determines if a service has the capability to answer the SQDL query. In our examples, this would be applied to all problems except Problem 3, whose solution requires two services, namely Service 2 and Service 3.

FIG. 4 shows one embodiment of a computer-implemented process of CBSSS. At a block 410, a user composes an SQDL query sentence in SQDL. The sentence is matched against the SCDL sentences associated with the available services of CBSSS in a block 420. Finally all matched services are listed in a block 430 for the user to choose.

### Meta-Level SCDL

There are situations that the SCDL language is not enough to describe a ‘class’ of SCDL expressions. To achieve this we need to introduce mata variables to represent a set of conditions, a set of commands, or a set of variable declarations so we can describe certain properties (constraints) of such variables.

Service 7: Given four classes account, customer, branch and depositor, select anything from these relations with any combination of relational comparisons between their attributes.
[SCDL]
SELECT META select
FROM META from
WHERE META where
META member(t,from)=>member(t.domain,[account,branch,customer,depositor])
META member(t,select)=>member(t.path, path(account) union path(branch) union path(customer) union path(depositor))
META member(t,where) AND member(s,t.arguments) AND isa(s,variable)=>member(s.path,path(account) union path(branch) union path(customer) union path(depositor)
META member(t,where)=>member(t.predicate,[<,>,=,!=,>=,<=])
   Service 8: Given four classes account, customer, branch and depositor, select anything from these relations with any combination of relational comparisons between their attributes, but the number of predicates cannot exceed 4.
[SCDL]
SELECT META select
FROM META from
WHERE META where
META IF member(t,from)

THEN member (t.domain, [account,branch,customer,depositor])
META IF member(t,select)

THEN member(t.path, path(account) union path(branch) union path(customer) union path(depositor))
META IF member(t,where) AND member(s,t.arguments) AND isa(s,variable)

THEN member(s.path, path(account) union path(branch) union path(customer) union path(depositor)
META IF member(t,where) THEN member(t.predicate,[<,>,=,!=,>=,<=])
META cardinality(where)<=4

### BRIEF DESCRIPTION OF THE DRAWINGS

FIG. 1 illustrates one embodiment of the semantic search system

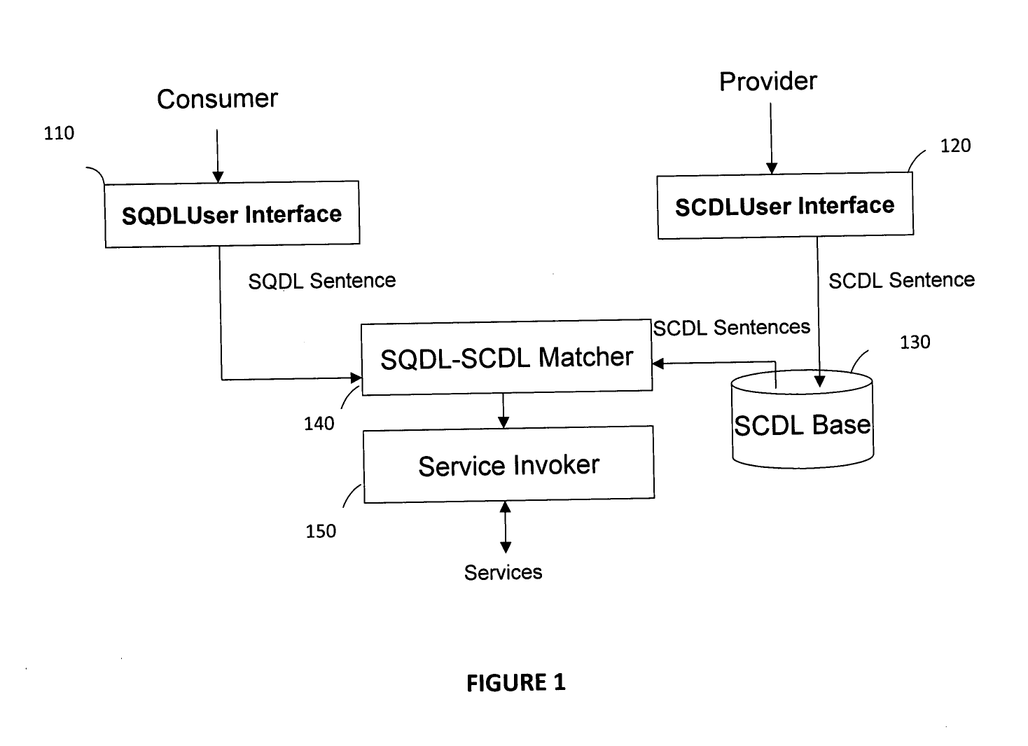

FIG. 2 illustrates one embodiment of the SCDL composition process

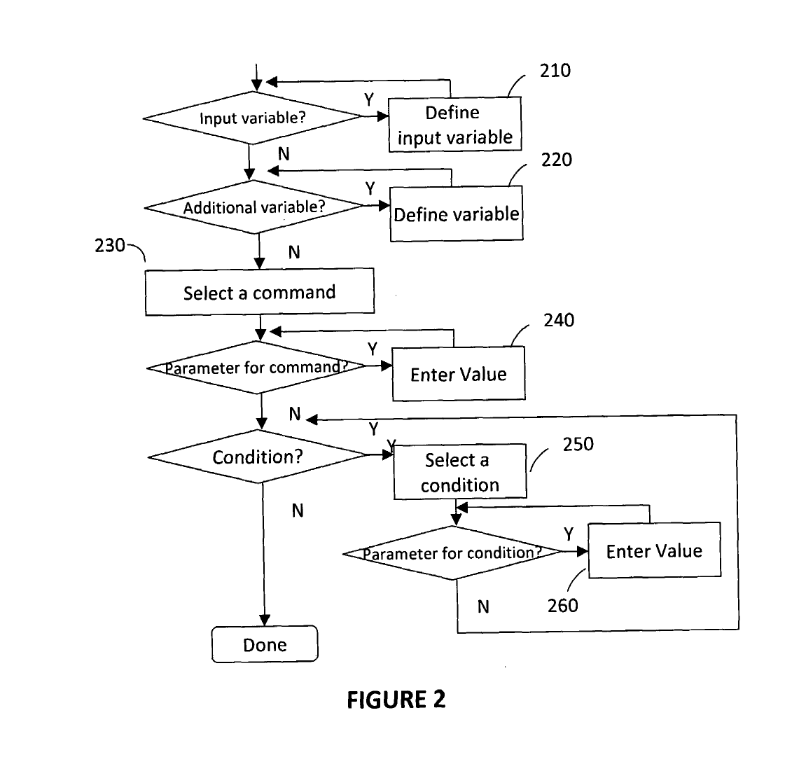

FIG. 3 illustrates one embodiment of the SQDL composition process

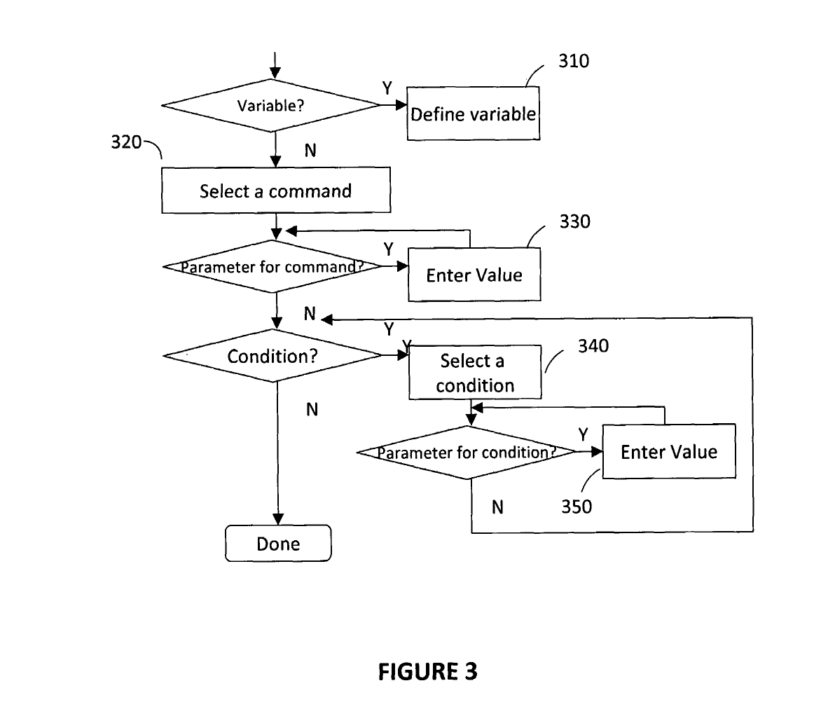

FIG. 4 illustrates one embodiment of the control flow of the system

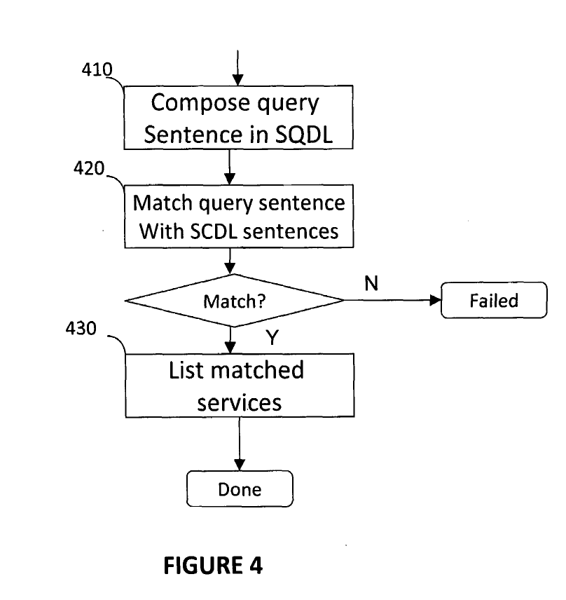

What is claimed is:

1. A capability based semantic search system, the system comprising
a computer interface that can be connected to a user that allows the user to compose search queries in a structured query language;
a computer interface that can be connected to the administrator of a web service that allows the administrator to compose the capability of the service in a structured query language and to register the service with the system;
a computer program that parses a structured user query sentence;
a computer program that parses a structured service capability sentence;
a storage that stores the structured capability sentences of all registered services;
a computer program that matches the user query sentence with the capability sentence of each registered service and returns those services whose capability can match the user query sentence.

2. The system of claim 1, further comprising a ranking module that ranks the result services returned.

3. The system of claim 1, further comprising a rating module that general users can provide their reviews about a service.

4. The system of claim 1, further comprising a computer program that passes a structured user query sentence to a matching service for execution.

5. The system of claim 1, further comprising a computer program that sends a structured user query sentence to a matching service for execution.

6. The system of claim 1, further comprising a computer program that receives and delivers to the user the result returned from a matching service after the corresponding structured user query sentence is executed by the service.

7. A computer-implemented method of composing a structured user query sentence, the method comprising:
prompting a user to define one or more variables;
prompting a user to select a command from at least a set of defined commands and specify its argument(s);
prompting the user to select one or more conditions from at least a set of defined conditions and their argument(s); and
combining the above into a structured user query sentence.

8. The method of claim 7, further comprising prompting the user to define the result of a user query sentence as a variable to be used as a parameter of a command or condition in another query.

9. The method of claim 7, wherein at least one of the previously defined commands was defined by a programmer or user using a definition module adapted to allow later selection by a user to compose a structured query sentence.

10. The method of claim 7, wherein at least one of the previously defined conditions was defined by a programmer or user using a definition module adapted to allow later selection by a user to compose a structured query sentence.

11. A computer-implemented method of composing a structured capability query sentence, the method comprising:
prompting a user to define one or more INPUT variables;
prompting a user to define one or more additional variables;
prompting a user to select a command from at least a set of defined commands and its argument(s);
prompting the user to select one or more conditions from at least a set of defined conditions and their argument(s); and
combining the above into a structured capability query sentence.

12. The method of claim 11, further comprising that a wildcard (‘*’) may be selected as the command that can be matched by any selected command in a structured query sentence.

13. The method of claim 11, further comprising that a wildcard (‘*’) may be selected as a condition that can be matched by any selected condition in a structured query sentence.

14. The method of claim 11, further comprising that a wildcard (‘*’) may be entered as the value of a parameter that can be matched by any value for the parameter in a structured query sentence.

15. The method of claim 11, wherein at least one of the previously defined commands was defined by a programmer or user using a definition module adapted to allow later selection by a user to compose a structured query sentence.

16. The method of claim 11, wherein at least one of the previously defined conditions was defined by a programmer or user using a definition module adapted to allow later selection by a user to compose a structured query sentence.

17. The method of claim 11, further comprising that multiple structured capability sentences may be defined for a service.

18. The method of claim 11, further comprising prompting the user to define a META variable as a set of commands, a set of variable declarations, or a set of conditions.

19. The method of claim 11, further comprising prompting the user to define a constraint on a META variable, that comprising:
prompting the user to compose the IF clause by selecting one or more conditions from at least a set of defined conditions and their parameter(s);
prompting the user to compose the THEN clause by selecting one or more conditions from at least a set of defined conditions and their parameter(s);

20. A computer-implemented method of matching a structured user query sentence and a structured capability query sentence, the method comprising:
Instantiating all variables in the structured query sentence if possible;
Matching the commands and their argument(s);
Matching the conditions and their argument(s).

21. The method of claim 20, further comprising that a structured query sentence may be matched by combining more than one structured capability query sentences.

22. The method of claim 20, further comprising that a service whose capability sentence that partially matches that of the structured user query is returned as a result.

23. A computer-implemented method of problem solving, the method comprising:
prompting a user to compose a structured query sentence;
matching the structured query sentence with the structured capability sentence of each service registered with the system and returns those services whose capability can match the user query sentence;
prompting a user to select one or more matching services.

24. The method of claim 24, further comprising that
instructing the user how to use a matching service after the service is selected;
the user subscribes a matching service as instructed.
